(19) United States
(12) Patent Application Publication
(10) Pub. No.: US 2014/0279351 A1
(43) Pub. Date: Sep. 18, 2014

(54) REPO ETF SYSTEM, AND METHOD

(71) Applicant: THE BANK OF NEW YORK MELLON, New York, NY (US)

(72) Inventors: Dean A. Christiansen, New York, NY (US); Stephen W. Cook, New York, NY (US)

(73) Assignee: THE BANK OF NEW YORK MELLON, New York, NY (US)

(21) Appl. No.: 13/843,039

(22) Filed: Mar. 15, 2013

(51) Int. Cl. G06Q 40/04

(52) U.S. Cl. CPC G06Q 40/04
USPC 705/37

(57) ABSTRACT

In one embodiment, a method for electronically trading shares of an exchange-traded fund over a network including one or more processors, the fund being a counterparty to one or more repurchasing parties in a repurchase agreement, includes receiving order data from one or more investors relating to a trade of shares of the fund. The method also includes matching the fund with the one or more repurchasing parties. The method additionally includes receiving securities data from the one or more repurchasing parties, and allocating the related securities to be used as collateral applied to the fund. The method additionally includes sending securities payment data for the securities to the one or more repurchasing parties. The method further includes receiving repurchase payment data from the one or more repurchasing parties to repurchase the securities used as collateral, and sending the securities data to the one or more repurchasing parties.

### BACKGROUND

This application is directed to a system and method useful for trading and processing repurchase agreements—for example, electronic trading of tri-party repurchase agreements in the form of an exchange-traded fund.

A repurchase agreement is a form of short-term borrowing for dealers in securities. The dealer sells the securities to investors, on an overnight or term basis, and buys them back either the following day or at the term of the agreement. For the party selling the securities (and agreeing to repurchase them in the future), it is a repurchase agreement; for the party buying the securities (and agreeing to sell them in the future), it is a reverse repurchase agreement. Repurchase agreements are classified as money-market instruments. Their most common use is raising short-term capital.

An exchange-traded fund is a security that tracks an index, a commodity, or a basket of assets like an index fund, but trades like a stock on an exchange. An exchange-traded fund experiences price changes throughout the day as it is bought and sold. Because it trades like a stock, an exchange-traded fund generally has its net asset value calculated daily, similar to a mutual fund. By owning an exchange-traded fund, an investor gets the diversification of an index fund, as well as the ability to sell short, buy on margin, and purchase as little as one share. Another advantage is that the expense ratio for the average exchange-traded fund is lower than that of the average mutual fund. Buying and selling an exchange-traded fund requires payment of the same commission to a broker that any regular order requires. One of the most widely known exchange-traded funds is called the Spider (SPDR), which tracks the S&P 500 index and trades under the symbol SPY. Exchange-traded funds are most commonly “index” funds, designed to move with their correlated “reference assets,” such as stocks of the S&P 500 or the Russell 2000. An emerging class of exchange-traded fund, however, includes funds that are “actively managed” in such a way as to allow more discretion and strategic influence on the part of the fund manager.

As mentioned above, common benefits of investing in an exchange-traded fund include lower cost (i.e., a lower average annual expense ratio than comparable mutual funds), tax efficiency (i.e., in-kind creation and redemptions underlying the structure minimizes capital gains), transparency (i.e., mutual funds report quarterly whereas exchange-traded funds make daily disclosure of holdings), and improved liquidity/tradability (i.e., investors can get in and out of units at any time during a trading day). Repurchase agreement investment has typically been limited to large, sophisticated investors.

Prior to about 2008, the short-end of the market had the liquidity supply dominated by securities dealers, conduits, and money-market funds. Dealers are limited by balance sheet capacity, transaction size, and eligible counterparties, whereas lending conduits are generally limited by balance sheet capacity, access to qualified investors, and third party credit support.

As for smaller investors, their investment options are generally limited to money-market funds, certificates of deposit, and possibly commercial paper. However, money-market funds lack easy transparency, and risk reaching the condition where the net asset value “breaks the buck.” Further, secondary market investors who are seeking liquidity and leverage have limited access to the professional capital markets.

Through the 2008-2011 financial crisis, liquidity evaporated for all but U.S. government and agency securities types, principally supported by the Federal Reserve's market intervention. As a result, many dealers stopped offering liquidity to all but their best customers, and lending conduits essentially disappeared. In addition, at least one money-market fund “broke the buck,” and breached the $1.00 net asset value level. Due to the lack of liquidity and pricing uncertainty during this time period, the market value of securities, and the underlying leveraged investment portfolios and liquidity pools dropped precipitously in value.

Following the financial crisis and continuing today, liquidity has improved somewhat, but the improved liquidity principally has benefited professional capital markets participants. Balance sheet constraints continued and increased, reflecting conservative capital ratio requirements of securities dealers, for example. Liquidity providers such as money-market funds and bank lending conduits remain challenged by the lack of transparency, access to back-up liquidity facilities and the uncertain regulatory environment. Middle and lower tier investors seeking security and transparency available by way of repurchase agreement programs still lack access to the markets because the repurchase agreement markets are geared for professional market participants. Finally, rates and yields remain greatly compressed and depressed, reflecting the Federal Reserve's continuing presence in the market, while a wide universe of securities types are still without sustainable liquidity support, which depresses values and dampens economic recovery.

What is needed is a system and method for active management of highly liquid money-market equivalent investments, particularly an exchange-traded investment that allows for market liquidity with high transparency for small, mid-level, and sophisticated investors alike, particularly a repurchase agreement-based investment offered as an exchange-traded fund.

### SUMMARY

According to an embodiment, a method for electronically trading shares of an exchange-traded fund over a network including one or more processors, the exchange-traded fund being a counterparty to one or more repurchasing parties in a repurchase agreement, includes receiving, via the one or more processors, order data from one or more investors relating to a trade of shares of the exchange-traded fund. The method also includes matching, via the one or more processors, the exchange-traded fund with repurchase agreement instructions received from the one or more repurchasing parties to the repurchase agreement. The method additionally includes receiving, via the one or more processors, securities data from the one or more repurchasing parties, and allocating, via the one or more processors, the received securities data relating to one or more securities to be used as collateral applied to an account of the exchange-traded fund. The method additionally includes sending, via the one or more processors, securities payment data for the one or more securities to the one or more repurchasing parties, the securities payment data relating to the one or more securities used as collateral. The method further includes, responsive to termination of the repurchase agreement, receiving, via the one or more processors, repurchase payment data from the one or more repurchasing parties to repurchase the one or more securities used as collateral, and sending, via the one or more processors, the securities data to the one or more repurchasing parties, the securities data relating to the one or more securities used as collateral.

According to another embodiment, a data processing system for trading shares of an exchange-traded fund, the exchange-traded fund being a counterparty to one or more repurchasing parties in a repurchase agreement, includes one or more processors coupled to a network connection and a memory containing a database therein, wherein the processors are configured to receive order data from one or more investors relating to a trade of shares of the exchange-traded fund. The processors are also configured to match the exchange-traded fund with repurchase agreement instructions received from the one or more repurchasing parties to the repurchase agreement. The processors are also configured to receive securities data from the one or more repurchasing parties, and allocate the received securities data relating to one or more securities to be used as collateral applied to an account of the exchange-traded fund. The processors are additionally configured to send securities payment data for the one or more securities used as collateral to the one or more repurchasing parties, the securities payment data relating to the one or more securities used as collateral. The processors are additionally configured to, responsive to termination of the repurchase agreement, receive repurchase payment data from the one or more repurchasing parties to repurchase the one or more securities used as collateral, and send the securities data to the one or more repurchasing parties, the securities data relating to the one or more securities used as collateral.

According to another embodiment, a data processing system for managing tri-party repurchase agreement exchange-traded fund transactions, includes one or more processors coupled to a network connection and a memory containing a database therein configured to at least store investor custody account data and repurchase agreement data including repurchase agreement-related collateral data therein, wherein the one or more processors are configured to receive a customer order from a customer for a trade of a repurchase agreement exchange-traded fund share. The processors are also configured to issue a cash order trade instruction to a repurchase agreement provider. The processors are additionally configured to match repurchase agreement instructions received from the repurchase agreement provider and from a repurchase agreement counterparty. The processors are additionally configured to receive securities data from the repurchase agreement counterparty and allocate the securities relating to the received securities data as collateral applied to an account of the exchange-traded fund. The processors are further configured to, responsive to receiving the securities data, send securities payment data to the repurchase agreement counterparty. The processors are further configured to electronically book trades executed by the repurchase agreement provider. The processors are also configured to provide, via the network connection, updated holdings, prices, and net asset value data to an indicative optimized portfolio value agent.

According to another embodiment, a method for electronically trading shares over a computer network includes receiving, via one or more processors in the computer network, a number of shares each representing a proportional interest in an exchange traded fund. A majority of assets in the exchange traded fund comprise interests in one or more repurchasing agreements.

According to another embodiment, a method for electronically trading shares over a computer network includes sending, via one or more processors in the computer network, a number of shares each representing a proportional interest in an exchange traded fund. A majority of assets in the exchange traded fund comprise interests in one or more repurchasing agreements.

According to another embodiment, a computer-implemented method of trading shares of an exchange traded fund with a majority of assets being interests in one or more repurchasing agreements, wherein the method is implemented in a computer system comprising one or more processors configured to execute one or more computer program modules, includes obtaining, on electronic storage media accessible to the one or more processors order data associated with the shares. The method also includes executing, on the one or more processors of the computer system, one or more computer program modules configured to transfer the shares of the exchange traded fund in response to the order data. The method further includes displaying, on an electronic display communicatively linked with the one or more processors of the computer system, information associated with the transfer.

Other features of this disclosure and the inventive concept described herein will be apparent to those skilled in the art based on the following drawings and detailed description.

### BRIEF DISCUSSION OF THE DRAWINGS

FIG. 1 illustrates an embodiment of a method 100 for electronically trading shares of an exchange-traded fund over a network.

FIG. 2 illustrates another embodiment of a method 200 for electronically trading shares of an exchange-traded fund over a network.

FIG. 3 illustrates an embodiment of a data processing system 400 for managing tri-party repurchase agreement exchange-traded fund transactions.

FIG. 4 illustrates an embodiment of a data processing system 600 for trading shares of an exchange-traded fund.

### DETAILED DESCRIPTION

In the discussion of various embodiments and aspects of the system and method of this disclosure, examples of a processor may include any one or more of, for instance, a personal computer, portable computer, personal digital assistant (PDA), tablet, web-enabled mobile phone, WAP device, web-to-voice device, or other processor-driven device, and examples of network may include, for example, a private network, the internet, or other known network types, including both wired and wireless networks.

Those with skill in the art may appreciate that the inventive concept described herein may work with various system configurations. In addition, various embodiments of this disclosure may be made in hardware, firmware, software, or any suitable combination thereof. Aspects of this disclosure may also be implemented as instructions stored on a machine-readable medium, which may be read and executed by one or more processors. A machine-readable medium may include any mechanism for storing or transmitting information in a form readable by a machine (e.g., a computing device, or a signal transmission medium), and may include a machine-readable transmission medium or a machine-readable storage medium. For example, a machine-readable storage medium may include read only memory, random access memory, magnetic disk storage media, optical storage media, flash memory devices, and others. Further, firmware, software, routines, or instructions may be described herein in terms of specific exemplary embodiments that may perform certain actions. However, it may be apparent that such descriptions are merely for convenience and that such actions in fact result from computing devices, processors, controllers, or other devices executing the firmware, software, routines, or instructions.

An exchange-traded fund structure could enable the formation of a new and highly liquid source of funding for fixed income securities and financing activities. Managed within a secure and highly transparent custodial environment, this new, actively managed exchange-traded fund strategy could offer yield levels competitive with those available in the professional capital-markets. The repurchase agreement exchange-traded fund structure is extendible, providing liquidity across a wide variety of asset classes.

A repurchase agreement exchange-traded fund may be beneficial for individual and smaller institutional cash investors seeking collateralization and yield available in repurchase agreements but not able to participate directly in the repurchase agreement markets and other securities classes to be financed with this strategy. It may also be very attractive to large investors that already can participate in the repurchase agreement markets.

FIG. 1 illustrates an embodiment of a method 100 for electronically trading shares of an exchange-traded fund 105 over a network. Investors 110, repurchasing parties 120, and a financial services provider 130 are interconnected via the network and may engage one another through it to conduct financial transactions. Investors 110 may trade shares by sending order data 140 to the financial services provider 130. The order data 140 corresponds with a purchase of a share of the exchange-traded fund 105. It may be appreciated that shares of the exchange-traded fund 105 may also be known as units of the exchange-traded fund 105. In some embodiments, the purchase of the share(s) may be performed multiple times throughout the day, and may settle the same day and/or multiple times a day. In some embodiments, settlement may occur at fixed times throughout the day (e.g., at set intervals). For example, in an embodiment there may be one daily funding/redemption time. In other embodiments, additional funding/redemption times may be established.

Accordingly, the financial services provider 130 may receive the order data 140. It may be appreciated that in some embodiments, the investors 110 could include individual investors. In other embodiments, the investors 110 could include institutional investors, municipalities and government investment pools, managed funds, agent lenders, and beneficial owners. Furthermore, the investors 110 could include new investors buying shares as well as current investors trading shares. Investors 110 could also include authorized participants. Likewise, it may be appreciated that in some embodiments, the financial service provider 130 could include banks. In other embodiments, the financial service provider 130 could include registered investment providers, dealers, or other financial institutions. In some embodiments, trades of the exchange-traded fund 105 could occur in the New York Stock Exchange. In other embodiments, the trades could occur in NASDAQ. In other embodiments, the trades could occur in another public exchange or a private exchange. Moreover, in some embodiments, the order data 140 may include order payment data from the investors 110. In other embodiments, the order data 140 may include instructions and authorization for the financial services provider 130 to take possession of some or all of the investors' 110 shares along with a request for payment from the financial services provider 130. Furthermore, in some embodiments, the order data 140 may include order payment data from the financial services provider 130 to the investors 110.

The exchange-traded fund 105 as a whole may be considered a counterparty to the repurchasing parties 120 in associated repurchase agreements. The financial service provider 130 may aggregate the investors' 110 order payment data into shares of the exchange-traded fund 105. The aggregation may include creation of units enabling additional investment by way of the fund. The financial services provider 130 may match 145 the exchange-traded fund 105 with repurchase agreement instructions 155 from these repurchasing parties 120, to invest money from the exchange-traded fund 105 into one or more repurchase agreement contracts. The exchange-traded fund 105 may include investment instructions. When a repurchase agreement commences, the repurchasing parties 120 may send securities data 150 to the financial services provider 130, wherein the financial services provider 130 may receive the securities data 150. The securities data 150 may include instructions and authorization for the financial services provider 130 to take possession of the securities that the repurchasing parties 120 may provide as collateral in the repurchase agreement. The financial services provider 130 may allocate the securities data 150 to an account of the exchange-traded fund 105. In return for the securities data 150, the financial services provider 130 may send securities payment data 160 to the repurchasing parties 120.

When the repurchase agreement terminates, the repurchasing parties 120 may send repurchase payment data 170 to the financial services provider 130, wherein the financial services provider 130 may receive the repurchase payment data 170. The repurchase payment data 170 may include instructions and authorization for the financial services provider 130 to take possession of the payment that the repurchasing parties 120 provided for the securities in the repurchase agreement. The financial services provider 130 may send the securities data 180 to the repurchasing parties 120 in return for the repurchase payment data 170. The securities data 180 may include instructions and authorization for the repurchasing parties 120 to re-take possession of the securities that the repurchasing parties 120 provided as collateral in the repurchase agreement.

In an embodiment, the investors 110 may sell their shares in the exchange-traded fund 105 at any appropriate time. For example, the sale of the share(s) may be performed multiple times throughout the day, and may settle the same day and/or multiple times a day. Again, in some embodiments, settlement may occur at fixed times throughout the day (e.g., at set intervals). In some embodiments, sale of the share(s) may result in redemption of one or more units.

It may be appreciated that in some embodiments, the repurchase agreement may be configured as a tri-party repurchase agreement. For example, FIG. 2 illustrates an embodiment of a method 200 for electronically trading shares of an exchange-traded fund over a network. Investors 210, repurchasing parties 220, a financial services provider 230, a financial services partner 310, a tri-party custodial environment 320, and a user interface 330 are interconnected via the network and may engage one another through it to conduct financial transactions. It may be appreciated that the investors 210 may in some embodiments be similar to the investors 110 as described above. It may also be appreciated that in some embodiments, the repurchasing parties 220 may be similar to the repurchasing parties 120 as described above. It may also be appreciated that in some embodiments, the financial services provider 230 may be similar to the financial services provider 130 as described above. Furthermore, it may be appreciated that in some embodiments, the order data 240 may be similar to the order data 140 as described above. It may also be appreciated that the securities data 250 may in some embodiments be similar to the securities data 150 as described above. It may also be appreciated that the securities payment data 260 may in some embodiments be similar to the securities payment data 160 as described above. It may also be appreciated that the repurchase payment data 270 may in some embodiments be similar to the repurchase payment data 170 as described above. It may additionally be appreciated that the securities data 280 may in some embodiments be similar to the securities data 180 as described above. The user interface 330 may be available externally to the investors 210. The user interface 330 may be used directly by the investors 210, or indirectly by the investors 210, such as through an agent of the investors 210. The user interface 330 may also receive input of the order data 240a from the investors 210 and relay the order data 240b to the financial services provider 230. Accordingly, the financial services provider 230 may receive the order data 240b. It is understood that the order data 240a, 240b, and 240c may all be the same order data 240 at different places in the network.

When a repurchase agreement commences, the repurchasing parties 220 may send the securities data 250 to the tri-party custodial environment 320, and the tri-party custodial environment 320 may receive the securities data 250. It may be appreciated that the tri-party custodial environment 320 may include banks in some embodiments. The financial services provider 230 may send fund payment data 340a to the tri-party custodial environment 320, wherein the tri-party custodial environment 320 may receive the fund payment data 340a and use it as the securities payment data 260. The tri-party custodial environment 320 then may send the securities payment data 260 in return for the securities used as collateral to the repurchasing parties 220. It is understood that the fund payment data 340a and 340b may all be the same fund payment data 340 at different places in the network.

The tri-party custodial environment 320 may store 275 at least the securities data 250. The tri-party custodial environment 320 also may verify 275 that the securities used as collateral represented by the securities data 250 provide over-collateralization using appropriate securities. It is understood that over-collateralization is the use of securities that are higher in value than the securities payment. Over-collateralization is useful because it lowers the risk that default by the repurchasing parties 220 may lower the net asset value of the exchange-traded fund. In one embodiment, appropriate securities could include United States government securities. In other embodiments, appropriate securities could include United States guaranteed agency securities, United States agency debenture securities, United States agency mortgage-backed securities, foreign sovereign debt securities, student loan asset-backed securities, residential mortgage-backed securities, commercial mortgage-backed securities, private label mortgages, commodities, currency, cash, or any other tradable asset. It may be appreciated that in some embodiments, any appropriate financial instrument, including but not limited to any appropriate financial asset or non-financial asset (e.g., real estate), may be utilized as a security. As such, the examples disclosed herein are not intended to be limiting in any way.

When the repurchase agreement terminates, the repurchasing parties 220 may send repurchase payment data 270 to the tri-party custodial environment 320, wherein the tri-party custodial environment 320 may receive the repurchase payment data 270 and use it as the fund payment data 340b. The tri-party custodial environment 320 may send the fund payment data 340b to the financial services provider 230. Furthermore, the tri-party custodial environment 320 may send the securities data 280 to the repurchasing parties 220 in return for the repurchase payment data 270. The securities data 280 may include instructions and authorization for the repurchasing parties 220 to re-take possession of the securities that the repurchasing parties 220 provided as collateral in the repurchase agreement.

The financial services provider 230 may send the order data 240c to the financial services partner 310 for execution. The execution may include transforming the order data 240c into trade data 350a and sending the trade data 350a to the financial services provider 230. The transforming may include investing the investors' 110 order payment data in repurchase agreements. Accordingly, the financial services provider 230 may receive the trade data 350a. The financial services provider 230 may then book 355 the received trade data 350a and send it 350b to the user interface 330, wherein the user interface 330 may receive the trade data 350b and allow the investors 210 to view the trade data 350c. The trade data 350c may include the history and status of the orders made by the investors 210. It is understood that the trade data 350a, 350b, and 350c may all be the same trade data 350 at different places in the network.

The financial services provider 230 may also compile 375 a report 370 on the securities used as collateral and may send the report 370 to the repurchasing parties 220, who may receive the report 370.

The financial services provider 230 may mark 365 the securities data 250 and the net asset value of the exchange-traded fund 360a to market one or more times per day. The financial services provider 230 may send securities holdings data, securities price data, and the net asset value of the exchange-traded fund 360a, to the user interface 330 one or more times per day. The investors 210 may view this data 360b in the user interface 330. It is understood that this data 360a and 360b may both be the same data at different places in the network. The securities holdings data 360 may include repurchase agreement information including the number and description of the securities held by the tri-party custodial environment 320. The securities price data 360 may include the prices of the securities held by the tri-party custodial environment 320. The net asset value 360 may include the price per share of the exchange-traded fund and the effective yield.

It may be appreciated that in some embodiments, the repurchase agreement may be configured as an integrated tri-party repurchase agreement. For example, FIG. 3 illustrates an embodiment of a data processing system 400 for managing tri-party repurchase agreement exchange-traded fund transactions. A customer 410, a repurchase agreement counterparty 420, a financial services provider 430, a repurchase agreement provider 510, an indicative optimized portfolio value agent 520, and a user interface 530 are interconnected via the network and may engage one another through it to conduct financial transactions. It may be appreciated that a customer 410 may in some embodiments be similar to the investors 210 as described above. It may also be appreciated that in some embodiments, the repurchase agreement counterparty 420 may be similar to the repurchasing parties 220 as described above. It may also be appreciated that in some embodiments, the financial services provider 430 may be similar to the financial services provider 230 as described above. Furthermore, it may be appreciated that in some embodiments, the customer order 440 including the cash order trade instruction 440c may be similar to the order data 240 as described above. It may also be appreciated that the securities data 450 may in some embodiments be similar to the securities data 250 as described above. It may also be appreciated that the securities payment data 460 may in some embodiments be similar to the securities payment data 260 as described above. It may also be appreciated that the repurchase payment data 470 may in some embodiments be similar to the repurchase payment data 270 as described above. It may additionally be appreciated that the securities data 480 may in some embodiments be similar to the securities data 280 as described above. It may additionally be appreciated that the repurchase agreement provider 510 may in some embodiments be similar to the financial services partner 310 as described above. It may additionally be appreciated that the user interface 530 may in some embodiments be similar to the user interface 330 as described above. It may additionally be appreciated that the trades view 550 may in some embodiments be similar to the trade data 350 as described above. It may additionally be appreciated that the updated holdings, prices, and net asset value data 560 may in some embodiments be similar to the securities holdings data, securities price data, and net asset value 360 as described above. It may further be appreciated that the report 570 may in some embodiments be similar to the report 370 as described above.

Before a repurchase agreement commences, the repurchase agreement provider may send the repurchase agreement instructions 580 to the financial services provider 430 and the repurchase agreement counterparty 420 may send the repurchase agreement instructions 590 to the financial services provider 430, and the financial services provider 430 may receive both. The financial services provider 430 then may match 445 both sets of instructions to commence the repurchase agreement. The financial services provider 430 may also store 455 the repurchase agreement instructions 580 and 590, as well as the securities data 450.

Additionally, the financial services provider 430 may electronically book trades executed by the repurchase agreement provider 510. Also, the financial services provider 430 may send the updated holdings, prices, and net asset value data 560a to the indicative optimized portfolio value agent 520. It is understood that the updated holdings, prices, and net asset value data 560a and 560b may all be the same updated holdings, prices, and net asset value data 560 at different places in the network.

It may be appreciated that the above-discussed embodiments may have one or more processors at various places in the network. For example, FIG. 4 illustrates an embodiment of a system 600 like the above-discussed embodiments. Investors 610, repurchasing parties 620, and a financial services provider 630 are interconnected via a network 640 and may engage one another through it to conduct financial transactions. It may be appreciated that the investors 610 may in some embodiments be similar to the investors 210 as described above. It may also be appreciated that in some embodiments, the repurchasing parties 620 may be similar to the repurchasing parties 220 as described above. It may also be appreciated that in some embodiments, the financial services provider 630 may be similar to the financial services provider 230 as described above. Furthermore, in some embodiments, the investors 610 may have their own processor(s) 650, the repurchasing parties 620 may have their own processor(s) 660, and the financial services provider 630 may have its own processor(s) 670, wherein these processors may interact with the network's 640 processor(s) 680. In other embodiments, the investors 610 and the repurchasing parties 620 may interact directly with the financial services provider's 630 processor(s) 670. Furthermore, in some embodiments, the financial services provider 630 may share one or more processors with the network 640, the user interface 330 discussed above, the tri-party custodial environment 320 discussed above, or the partner 310 or repurchase agreement provider 510 discussed above, or some combination thereof.

Although the methods and systems described herein are associated with transmission of data and instructions associated with securities, collateral, or other assets, it may be appreciated that data indicating a transfer of ownership of an asset may or may not be associated with a movement of custody of the asset itself. For example, while in some embodiments a transfer of ownership may be initiated or cleared generally concurrently with the instruction or data being processed, in other embodiments the asset may be held by one or more parties (e.g., in escrow) until such time that clearance and a transfer of the asset itself is performed. As such, any time there is a movement of data or orders indicated in the illustrated flowcharts, it may include the movement of the assets themselves.

The above-discussed embodiments and aspects of this disclosure are not intended to be limiting, but have been shown and described for the purposes of illustrating the functional and structural principles of the inventive concept, and are intended to encompass various modifications that would be within the spirit and scope of the following claims. As one example, it may be appreciated that the systems and methods disclosed herein in the context of repurchase agreements may similarly be applicable in the context of securities lending agreements.

Various embodiments may be described herein as including a particular feature, structure, or characteristic, but every aspect or embodiment may not necessarily include the particular feature, structure, or characteristic. Further, when a particular feature, structure, or characteristic is described in connection with an embodiment, it may be understood that such feature, structure, or characteristic may be included in connection with other embodiments, whether or not explicitly described. Thus, various changes and modifications may be made to this disclosure without departing from the scope or spirit of the inventive concept described herein. As such, the specification and drawings should be regarded as examples only, and the scope of the inventive concept to be determined solely by the appended claims.

What is claimed is:

1. A method for electronically trading shares of an exchange-traded fund over a network including one or more processors, the exchange-traded fund being a counterparty to one or more repurchasing parties in one or more repurchase agreements, the method comprising:
aggregating, via the one or more processors, investments represented by order data from one or more investors into shares of the exchange-traded fund;
matching, via the one or more processors, investments in the exchange-traded fund with repurchase agreement instructions associated with the one or more repurchasing parties to establish associated ones of the one or more repurchase agreements;
receiving, via the one or more processors, securities data from the one or more repurchasing parties, and allocating one or more securities represented by the received securities data as collateral applied to an account of the exchange-traded fund;
sending, via the one or more processors, payment for the one or more securities to the one or more repurchasing parties in exchange for the securities used as collateral, the payment being represented by securities payment data; and
responsive to termination of one or more of the repurchase agreements, receiving, via the one or more processors, repurchase payment data from associated ones of the one or more repurchasing parties to repurchase the one or more securities used as collateral, and sending, via the one or more processors, the securities data to the associated one or more repurchasing parties, the securities data relating to the one or more securities used as collateral.

2. The method of claim 1, further comprising sending, via the one or more processors, the order data to a partner for execution of the order to transform the order data to trade data and send the trade data to the one or more processors.

3. The method of claim 2, further comprising receiving, via the one or more processors, the trade data from the partner, and booking, via the one or more processors, the received trade data.

4. The method of claim 1, further comprising compiling, via the one or more processors, a report on the one or more securities used as collateral, and sending, via the one or more processors, the report on the one or more securities used as collateral to the one or more repurchasing parties.

5. The method of claim 1, wherein trades of the exchange-traded fund occur in one or more of New York Stock Exchange, NASDAQ, and a private exchange.

6. The method of claim 1, further comprising marking to market, via the one or more processors, the securities data one or more times in a day, the securities data relating to the one or more securities used as collateral.

7. The method of claim 1, further comprising marking to market, via the one or more processors, net asset value of the exchange-traded fund one or more times in the day.

8. The method of claim 1, further comprising making externally available to the one or more investors a user interface.

9. The method of claim 8, further comprising sending, via the one or more processors, securities holdings data relating to the used as collateral, securities price data relating to the one or more securities used as collateral, and the net asset value of the exchange-traded fund to the user interface one or more times in the day.

10. The method of claim 8, further comprising receiving, in the user interface, input of the order data from the one or more investors.

11. The method of claim 8, further comprising displaying, in the user interface, the trade data of the exchange-traded fund after the trade data arrives to the one or more investors.

12. The method of claim 1, further comprising storing in a tri-party custodial environment at least the securities data relating to the one or more securities used as collateral.

13. The method of claim 12, wherein the tri-party custodial environment is configured to receive, via the one or more processors, the securities data from the one or more repurchasing parties, and send, via the one or more processors, the securities payment data for the one or more securities used as collateral to the one or more repurchasing parties.

14. The method of claim 12, wherein the tri-party custodial environment is configured, responsive to the termination of the one or more of the repurchase agreements, to receive, via the one or more processors, the repurchase payment data from the associated ones of the one or more repurchasing parties, and send, via the one or more processors, the securities data to the associated repurchasing parties, the securities data relating to the one or more securities used as collateral.

15. The method of claim 12, wherein the tri-party custodial environment is configured to verify, via the one or more processors, that the one or more securities used as collateral represented by the securities data provide over-collateralization using appropriate securities.

16. The method of claim 1, wherein one or more of the repurchase agreements terminates after a term of one day, one week, two weeks, three weeks, one month, two months, three months, four months, five months, six months, or combinations thereof.

17. The method of claim 1, wherein one or more of the repurchase agreements terminates after a laddered term.

18. The method of claim 1, wherein one or more of the repurchase agreements terminates after a blended term.

19. The method of claim 1, wherein the one or more securities used as collateral comprise one or more of United States government securities, United States guaranteed agency securities, United States agency debenture securities, United States agency mortgage-backed securities, foreign sovereign debt securities, student loan asset-backed securities, residential mortgage-backed securities, commercial mortgage-backed securities, private label mortgages, commodities, currency, and cash.

20. The method of claim 1, wherein the one or more investors comprise one or more of individual investors, institutional investors, municipalities and government investment pools, managed funds, agent lenders, and beneficial owners.

21. A data processing system for trading shares of an exchange-traded fund, the exchange-traded fund being a counterparty to one or more repurchasing parties in one or more repurchase agreements, the system comprising:
one or more processors coupled to a network connection and a memory containing a database therein,
wherein the processors are configured to:
aggregate investments represented by order data from one or more investors into shares of the exchange-traded fund;
match investments in the exchange-traded fund with repurchase agreement instructions associated with the one or more repurchasing parties to establish associated ones of the one or more repurchase agreements;
receive securities data from the one or more repurchasing parties, and allocate one or more securities represented by the received securities data as collateral applied to an account of the exchange-traded fund;
send payment for the one or more securities used as collateral to the one or more repurchasing parties in exchange for the securities used as collateral, the payment being represented by securities payment data;
responsive to termination of one or more of the repurchase agreements, receive repurchase payment data from associated ones of the one or more repurchasing parties to repurchase the one or more securities used as collateral, and send the securities data to the associated one or more repurchasing parties, the securities data relating to the one or more securities used as collateral.

22. The system of claim 21, wherein the one or more processors are further configured to send the order data to a partner for execution of the order data to transform the order data to trade data and send the trade data to the one or more processors.

23. The system of claim 22, wherein the one or more processors are further configured to receive the trade data from the partner and book the received trade data.

24. The system of claim 21, wherein the one or more processors are further configured to compile a report on the one or more securities used as collateral and send the report on the one or more securities used as collateral to the one or more repurchasing parties.

25. The system of claim 21, wherein trades of the exchange-traded fund occur in one or more of New York Stock Exchange, NASDAQ, and a private exchange.

26. The system of claim 21, wherein the one or more processors are further configured to mark to market the securities data one or more times in a day, the securities data relating to the one or more securities used as collateral.

27. The system of claim 21, wherein the one or more processors are further configured to mark to market net asset value of the exchange-traded fund one or more times in the day.

28. The system of claim 21, further comprising a user interface available externally to the one or more investors.

29. The system of claim 28, wherein the one or more processors are further configured to send securities holdings data relating to the one or more securities used as collateral, securities price data relating to the one or more securities used as collateral, and the net asset value of the exchange-traded fund to the user interface one or more times in the day.

30. The system of claim 28, wherein the user interface is further configured to receive input of the order data from the one or more investors.

31. The system of claim 28, wherein the user interface is further configured to allow the one or more investors to view the trade data of the exchange-traded fund after the trade data arrives.

32. The system of claim 21, further comprising a tri-party custodial environment configured to store, via the one or more processors, at least the securities data relating to the one or more securities used as collateral therein.

33. The system of claim 32, wherein the tri-party custodial environment is further configured to receive, via the one or more processors, the securities data from the one or more repurchasing parties, and send, via the one or more processors, the securities payment data for the one or more securities used as collateral to the one or more repurchasing parties, the securities data relating to the one or more securities used as collateral.

34. The system of claim 32, wherein the tri-party custodial environment is further configured, responsive to the termination of the one or more of the repurchase agreements, to receive, via the one or more processors, the repurchase payment data from the associated ones of the one or more repurchasing parties, and send, via the one or more processors, the securities data to the associated one or more repurchasing parties, the securities data relating to the one or more securities used as collateral.

35. The system of claim 32, wherein the tri-party custodial environment is further configured to verify, via the one or more processors, that the one or more securities used as collateral represented by the securities data provide over-collateralization using appropriate securities.

36. The system of claim 21, wherein one or more of the repurchase agreements terminates after a term of one day, one week, two weeks, three weeks, one month, two months, three months, four months, five months, six months, or combinations thereof.

37. The system of claim 21, wherein one or more of the repurchase agreements terminates after a laddered term.

38. The system of claim 21, wherein one or more of the repurchase agreements terminates after a blended term.

39. The system of claim 21, wherein the one or more securities used as collateral comprise one or more of United States government securities, United States guaranteed agency securities, United States agency debenture securities, United States agency mortgage-backed securities, foreign sovereign debt securities, student loan asset-backed securities, residential mortgage-backed securities, commercial mortgage-backed securities, private label mortgages, commodities, currency, and cash.

40. The system of claim 21, wherein the one or more investors comprise one or more of individual investors, institutional investors, municipalities and government investment pools, managed funds, agent lenders, and beneficial owners.

41. A data processing system for managing tri-party repurchase agreement exchange-traded fund transactions, the system comprising:
one or more processors coupled to a network connection and a memory containing a database therein configured to at least store investor custody account data and repurchase agreement data including repurchase agreement-related collateral data therein,
wherein the one or more processors are configured to:
receive a customer order from a customer for a trade of a repurchase agreement exchange-traded fund share;
issue a cash order trade instruction to a repurchase agreement provider;
match repurchase agreement instructions received from the repurchase agreement provider with repurchase agreement instructions received from a repurchase agreement counterparty;
receive securities data from the repurchase agreement counterparty and allocate one or more securities relating to the received securities data as collateral applied to an account of the exchange-traded fund;
responsive to receiving the securities data, send payment for the one or more securities to the repurchase agreement counterparty, the payment being represented by securities payment data;
electronically book trades executed by the repurchase agreement provider; and
provide, via the network connection, updated holdings, prices, and net asset value data to an indicative optimized portfolio value agent.

42. The system of claim 41, wherein the one or more processors are further configured to, responsive to termination of the repurchase agreement, receive repurchase payment data from the repurchase agreement counterparty to repurchase the securities applied as collateral, and send the securities data to the repurchase agreement counterparty.

43. The system of claim 41, wherein the one or more processors are further configured to compile a report on the securities applied as collateral and send the report on the securities applied as collateral to the repurchase agreement counterparty.

44. The system of claim 41, wherein trades executed by the repurchase agreement provider originate in one or more of New York Stock Exchange, NASDAQ, and a private exchange.

45. The system of claim 41, further comprising a user interface available externally to the customer.

46. The system of claim 45, wherein the one or more processors are further configured to send the updated holdings, prices, and net asset value data to the user interface one or more times in a day.

47. The system of claim 45, wherein the user interface is further configured to receive input of the customer order.

48. The system of claim 45, wherein the user interface is further configured to allow the customer to view the trades executed by the repurchase agreement provider.

49. The system of claim 41, wherein the one or more processors are further configured to verify that the securities applied as collateral provide over-collateralization using appropriate securities.

50. The system of claim 41, wherein a repurchase agreement associated with the repurchase agreement exchange-traded fund terminates after a term of one day, one week, two weeks, three weeks, one month, two months, three months, four months, five months, six months, or combinations thereof.

51. The system of claim 50, wherein the repurchase agreement terminates after a laddered term.

52. The system of claim 50, wherein the repurchase agreement terminates after a blended term.

53. The system of claim 41, wherein the securities applied as collateral comprise one or more of United States government securities, United States guaranteed agency securities, United States agency debenture securities, United States agency mortgage-backed securities, foreign sovereign debt securities, student loan asset-backed securities, residential mortgage-backed securities, commercial mortgage-backed securities, private label mortgages, commodities, currency, and cash.

54. The system of claim 41, wherein the customer comprises one or more of individual investors, institutional investors, municipalities and government investment pools, managed funds, agent lenders, and beneficial owners.

55. A method for electronically trading shares over a computer network, the method comprising:
receiving, via one or more processors in the computer network, a number of shares each representing a proportional interest in an exchange traded fund;
wherein a majority of assets in the exchange traded fund comprise interests in one or more repurchasing agreements.

56. A method for electronically trading shares over a computer network, the method comprising:
sending, via one or more processors in the computer network, a number of shares each representing a proportional interest in an exchange traded fund;
wherein a majority of assets in the exchange traded fund comprise interests in one or more repurchasing agreements.

57. A computer-implemented method of trading shares of an exchange traded fund with a majority of assets being interests in one or more repurchasing agreements, wherein the method is implemented in a computer system comprising one or more processors configured to execute one or more computer program modules, the method comprising;
obtaining, on electronic storage media accessible to the one or more processors order data associated with the shares;
executing, on the one or more processors of the computer system, one or more computer program modules configured to transfer the shares of the exchange traded fund in response to the order data; and
displaying, on an electronic display communicatively linked with the one or more processors of the computer system, information associated with the transfer.
